(19) United States
(12) Patent Application Publication
(10) Pub. No.: US 2017/0284878 A1
(43) Pub. Date: Oct. 5, 2017

(54) LOAD DETECTION APPARATUS

(71) Applicant: AISIN SEIKI KABUSHIKI KAISHA, Kariya-shi, Aichi (JP)

(72) Inventors: Toshihito NAGAI, Anjo-shi (JP); Kenichi TAGUCHI, Toyota-shi (JP); Yasukuni OJIMA, Kariya-shi (JP)

(73) Assignee: AISIN SEIKI KABUSHIKI KAISHA, Kariya-shi, Aichi (JP)

(21) Appl. No.: 15/510,736

(22) PCT Filed: Nov. 17, 2015
(86) PCT No.: PCT/JP2015/082247

§ 371 Date: Mar. 13, 2017

(30) Foreign Application Priority Data
Nov. 21, 2014 (JP) 2014-236618

(51) Int. Cl. G01L 5/22; G01L 1/22

(52) U.S. Cl. CPC G01L 5/225; G01L 1/22

(57) ABSTRACT

A load detection apparatus is provided, which can protect a control circuit portion reliably while a load sensor and the control circuit portion are arranged compactly. The load detection apparatus includes a base plate, a load sensor provided at a first surface of the base plate, a control circuit portion provided at a position on a second surface of the base plate, the position not overlapping the load sensor in a plan view of the base plate, a protection cover covering the control circuit portion, the protection cover includes a base portion covering at least part of a position on the second surface, the position facing the load sensor with the base plate therebetween, a raised portion being continuous to the base portion, and a cover portion being continuous to the raised portion and covering the control circuit portion.

### TECHNICAL FIELD

The invention relates to a load detection apparatus provided with a load sensor.

### BACKGROUND ART

A load detection apparatus electrically detects, with a load sensor, a load of an object and/or an operation force applied to a movable member, for example. For example, Patent document 1 shows a load detection apparatus detecting an operating tierce of an operation pedal for a vehicle.

A load sensor is connected to a control circuit portion. For example, a load and/or an operation force which are on the basis of a detection value of the load sensor are calculated at the control circuit portion. According to Patent document 1, the load sensor is connected via a wire harness to the control circuit portion mounted on a vehicle.

In addition, conventionally, a load sensor and a control circuit may be arranged to be close to each other. For example, according to a technique described in Patent document 2, a control circuit portion is accommodated in a case portion adjacent to a sensor, and an opening of the case portion is closed with a cover.

### DOCUMENT OF PRIOR ART

### Patent Document

Patent document 1: JP2008-281547A

Patent document 2: JP2011-14456A

### OVERVIEW OF INVENTION

### Problem to be Solved by Invention

According to the above-described known techniques, however, a space portion for the case portion accommodating the control circuit portion is necessary, and thus an entire apparatus might be increased in size. Even in a case where the control circuit portion is not accommodated in the case portion, the load sensor and the control circuit portion need to be arranged to be separate from each other so that they do not interfere with each other. Accordingly, there are limitations in an integrated configuration of the load sensor and the control circuit portion.

There is a need for a load detection apparatus in which a load sensor and a control circuit portion are arranged compactly, while the control circuit portion can be protected reliably.

### Means for Solving Problem

A characteristic configuration of a load detection apparatus related to the invention is that the load detection apparatus includes a base plate, a load sensor provided at one surface of the base plate, a control circuit portion provided at a position on another surface of the base plate, the position not overlapping the load sensor in a plan view of the base plate, and a protection cover covering the control circuit portion. The protection cover includes a base portion covering at least part of a position on the above-described another surface, the position facing the load sensor with the base plate therebetween, a raised portion being continuous to the base portion, and a cover portion being continuous to the raised portion and covering the control circuit portion.

Because the load sensor is arranged at a first surface provided at one side of the base plate, and the control circuit portion is arranged at the position on a second surface serving as the above-described another surface of the base plate, the position not overlapping the load sensor in the plan view of the base plate as in the embodiment, the load sensor and the control circuit portion can be arranged at the positions that are close to each other with the base plate therebetween. As described above, by arranging the load sensor and the control circuit portion at the respective sides of the base plate in such a manner that the load sensor and the control circuit portion are distributed to the both sides of the base plate, the control circuit portion can be arranged to follow outer portion of an object to be measured while the load sensor are embedded in the member serving as the object to be measured, for example. Thus, a degree of freedom in the attachment relative to the measuring object is enhanced. In addition, the configuration in which the control circuit portion and the load sensor are arranged at the front side and the rear sides of the base plate, respectively, is an extremely simple configuration, thereby simplifying the configuration and making a cost reduction possible.

Further, according to the configuration, the protection cover includes the base portion covering at least part of the position on the second surface, the position which faces the load sensor across the base plate, the raised portion which is continuous to the base portion, and the cover portion which is continuous to the raised portion and covers the control circuit portion. Thus, a large attachment region of the base portion of the protection cover is secured at the base plate. Consequently, the protection cover can be held robustly at the base plate and the control circuit portion can be protected reliably.

Another characteristic configuration of the invention is that a communication portion for a wire connecting the load sensor and the control circuit portion to each other is provided at the base plate.

At the base plate, the load sensor is arranged at the first surface and the control circuit portion is arranged at the second surface. Thus, in a case where the communication portion for the wire connecting the load sensor and the control circuit portion to each other is provided at the base plate as in this configuration, the load sensor and the control circuit portion can be connected to each other easily. In addition, because the protection cover is arranged at the first surface of the base plate, the wire arranged through the communication portion can be protected by the protection cover.

Another characteristic configuration of the invention is that a fixing portion of the base portion relative to the base plate is provided at at least three points or more in a dispersed manner to form a polygonal shape.

Because the fixing portion of the base portion is provided at at least three points or more points in the dispersed manner to form the polygonal shape as in the embodiment, even if an external force supposedly applies to the cover portion and the base portion is made to come off from the base plate, the plural fixing portions can reliably inhibit the base portion from coming off. For example, in a case where the external force acts on the cover portion and the base portion is to come off while the raised portion that is continuous to the base portion serving as a fulcrum point, the fixing portion that is the farthest from the raised portion functions effectively because the fixing points are provided to form the polygonal shape. That is, a fixing strength of the fixing portion is associated with a distance from the raised portion, and thus a fixing state of the protection cover can be more stabilized by ensuring the distance to be long.

Another characteristic configuration of the invention is that the load sensor is formed of a strain generating body and a sensor main body which are divided from each other, a hole portion through which a shaft portion supporting the strain generating body is inserted is formed at the base portion, and a come-off-prevention portion preventing the strain generating body from coming off towards the base portion is provided at an edge portion of the hole portion.

Because the load sensor is formed to be divided into the strain generating body and the sensor main body as in the embodiment, for example, in a case where the load sensor is attached to a certain type of operation member, the strain generating body is in a state of not easily deforming when the operation member is not being operated and the strain generating body is in a state of easily deforming via the sensor main body when the operation member is being operated. That is, by separating the sensor main body and the strain generating body from each other, it is prevented that a load like a noise is transmitted to the strain generating body and detected in a state where the operation member is not being operated.

In a case where the load sensor includes the divided configuration as described above, the strain generating body needs to be protected from coming off from the operation member. In the configuration, the hole portion through which the shaft portion inserted in the strain generating body is inserted is formed at the base portion, and the come-off-prevention portion preventing the strain generating body from coming off towards the base portion is provided at the edge portion of the hole portion. Accordingly, the coming-off of the strain generating body can be stably prevented and the load sensor including a high detection accuracy can be obtained.

Another characteristic configuration of the invention is that the come-off-prevention portion is formed by being bent towards the strain generating body.

Because the come-off-prevention portion is formed by being bent towards the strain generating body as in the configuration, the come-off-prevention portion can be in contact with the strain generating body that is positioned at a further innermost side of the base plate. Consequently, an excessive backlash or rattling of the strain generating body can be prevented, and the strain generating body can be held in a more stable manner. Further, as the bent portion is being bent, a surface of the come-off-prevention portion is inclined toward an innermost side of the hole portion. Accordingly, the come-off-prevention portion can be used as a guide portion of the shaft portion when the shaft portion is being inserted into the strain generating body, which makes an attachment operation of the load sensor easy.

### BRIEF DESCRIPTION OF DRAWINGS

FIG. 1 is a side view of an operation pedal apparatus for a vehicle.

FIG. 2 is a sectional side view of major portions of the operation pedal apparatus for the vehicle.

FIG. 3 is a cross-sectional view as viewed from the direction of the arrow, the cross-sectional view which is taken along line III-III of FIG. 1.

FIG. 4 is a top cross-sectional view of major portions of a load detection apparatus.

FIG. 5 is a perspective view of the load detection apparatus.

FIG. 6 is an exploded perspective view of the load detection apparatus.

### MODE FOR CARRYING OUT THE INVENTION

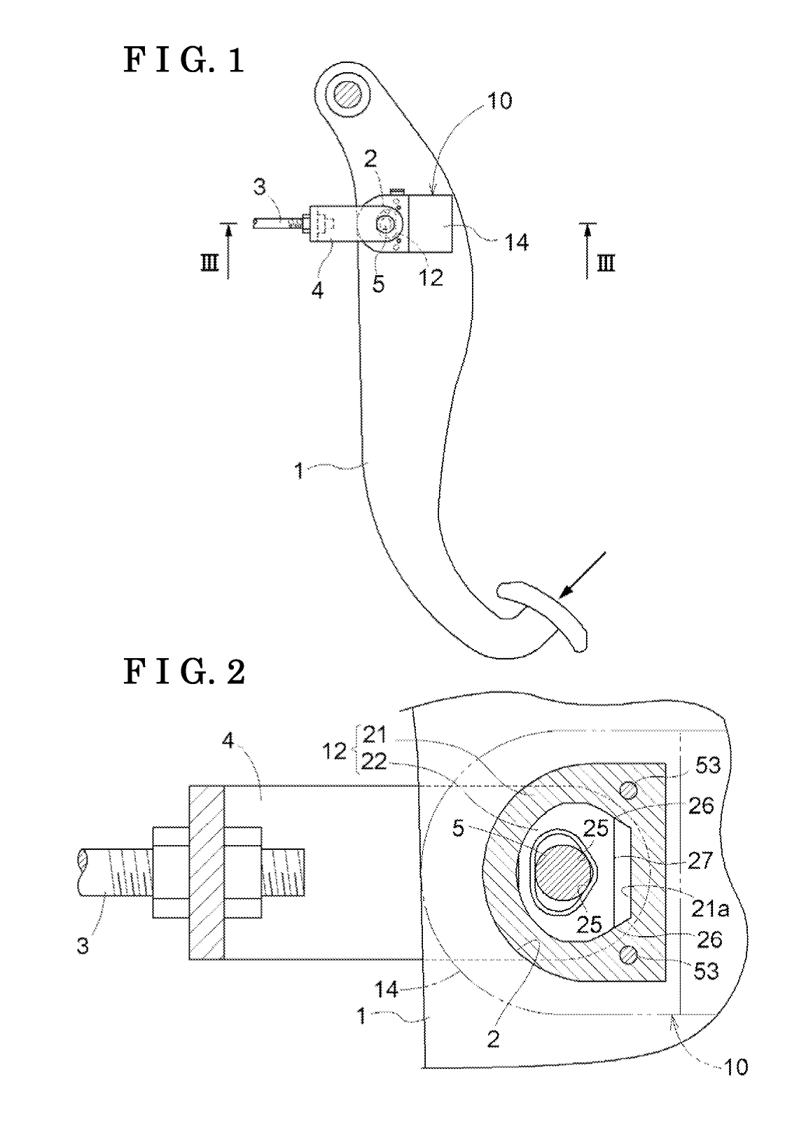

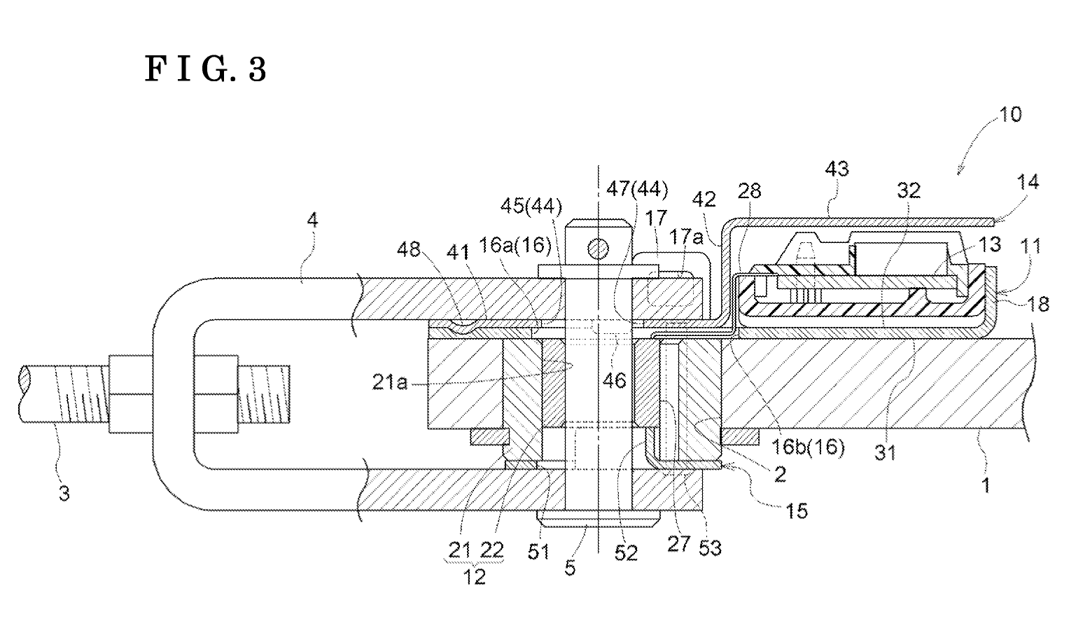

A load detection apparatus of an embodiment will be described hereunder on the basis of the drawings. As described in FIGS. 1 to 3, a load detection apparatus 10 is provided at a pedal 1 used for a brake of a vehicle, for example. The load sensor apparatus 10 includes a load sensor 12 and the load sensor 12 is arranged at an attachment hole 2 provided at the pedal 1. A shaft portion 5 is provided at a rotary connection portion 4 connecting the pedal 1 and a reaction force member 3 to each other in a manner that the pedal 1 and the reaction force member 3 are rotatable relative to each other. The reaction force member 3 is connected to a master cylinder that is not shown. The load sensor 12 detects an operation force transmitted via the shaft portion 5 of the rotary connection portion 4.

As illustrated in FIGS. 2 to 6, the load detection apparatus 10 includes a base plate 11, the load sensor 12, a control circuit portion 13 and a protection cover 14 covering the control circuit portion 13. The load sensor 12 is arranged at a first surface 31 of the base plate 11. The control circuit portion 13 is provided at a second surface 32 of the base plate 11 so as to be arranged at a position which does not overlap the load sensor 12 in a plan view of the base plate 11.

As illustrated in FIGS. 2 to 4, the load sensor 12 includes a strain generating body 22 formed in a cylindrical configuration and is accommodated in a hole portion 21a of a sensor main body 21. That is, the load sensor 12 is formed by the strain generating body 22 and the sensor main body 21 which are divided or are separate from each other. The load sensor 12 detects a load applied from the shaft portion 5 inserted in the strain generating body 22 to the strain generating body 22 in a radial direction.

Because the load sensor 12 is configured in a manner that the load sensor 12 is divided into the strain generating body 22 and the sensor main body 21, in a case where the load sensor 12 is attached to the pedal 1, the strain generating body 22 is in a state of not easily deforming when the pedal 1 is not being operated and the strain generating body 22 is in a state of easily deforming via the sensor main body 21 when the pedal 1 is being operated. That is, by separating the sensor main body 21 and the strain generating body 22 from each other, it is prevented that a load like a noise is transmitted to the strain generating body 22 and detected in a state where the pedal 1 is not being operated.

A support plate 15 is arranged at an opposite side of the load sensor 2 which is opposite to the base plate 11. By arranging the load sensor 12 and the control circuit portion 13 at the respective sides of the base plate 11 so as to be distributed to the both sides of the base plate 11, the control circuit portion 13 can be arranged to follow an outer portion of the pedal 1 while the load sensor 12 is arranged to be embedded in the pedal 1 serving as an object to be measured, for example. Thus, a degree of freedom in the attachment relative to the pedal 1 is enhanced. In addition, the configuration in which the control circuit portion 13 and the load sensor 12 are arranged at the front side and the rear side of the base plate 11, respectively, is an extremely simple configuration, thereby simplifying the configuration and making a cost reduction possible.

As the pedal 1 is pressed on, the shaft portion 5 moves relative to the strain generating body 22 and acts on a load receiving portion 25 of the strain generating body 22. The load received by the strain generating body 22 is transmitted to a load transmission portion 26 of the sensor main body 21. At this time, the strain generated at the strain generating body 22 is detected by a strain detection surface 27 provided at the strain generating body 22.

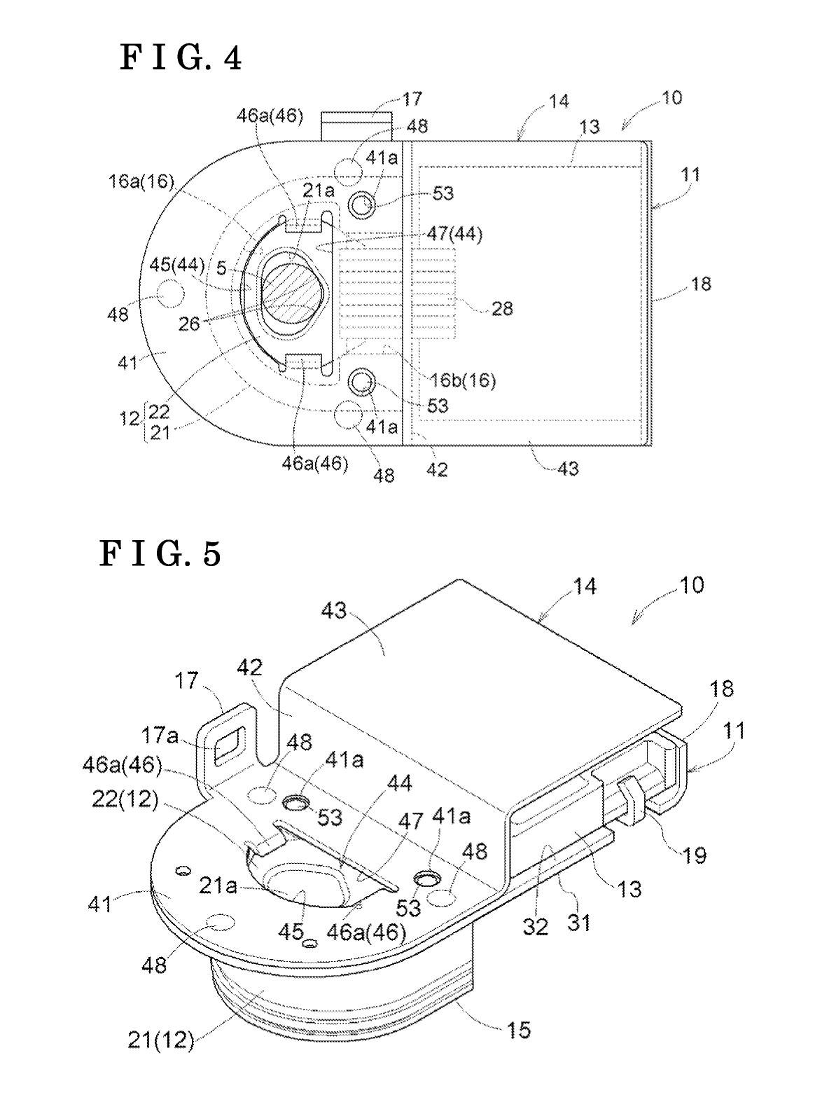

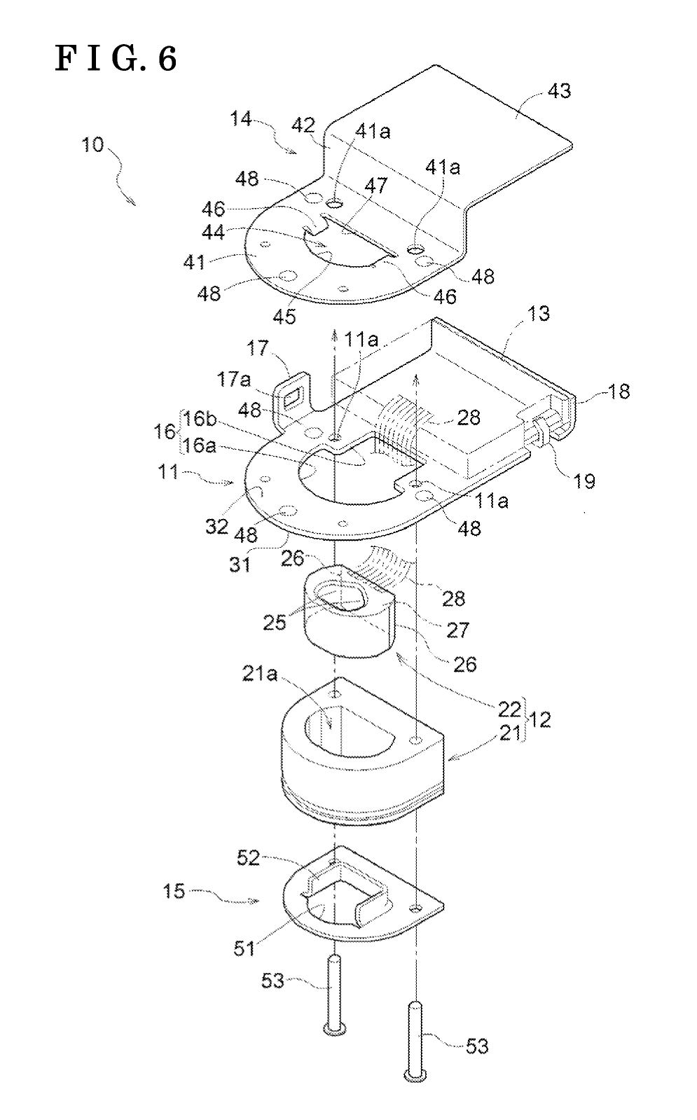

The load sensor 12 is connected to the control circuit portion 13 via wire 28 formed by, for example. FPC (flexible printed circuit board). The base plate 11 includes a hole portion 16 formed at a portion at which the load sensor 12 is arranged. As illustrated in FIGS. 4 and 6, the hole portion 16 includes a first hole portion 16a corresponding to the strain generating body 22 and a second hole portion 16b extended from the first hole portion 16a to the vicinity of the control circuit portion 13. The second hole portion 16b serves as a communication portion for the wire 28 connecting the load sensor 12 and the control circuit portion 13 to each other.

The protection cover 14 includes a base portion 41 fixed to the base plate 11, a raised portion 42 which is continuous to the base portion 41, and a cover portion 43 which is continuous to the raised portion 42 and covers the control circuit portion 13. The base portion 41 covers at least part of a position on the second surface 32 of the base plate 11, the position which faces the load sensor 12 with the base plate 11 therebetween. In the embodiment, the base portion 41 is configured to cover the entire load sensor 12. Accordingly, due to the base portion 41, the protection cover 14 is held at the base plate 11 in a stable state, thereby protecting the control circuit portion 13 reliably.

The base portion 41 includes a hole portion 44 formed at a position corresponding to the first hole portion 16a of the base plate 11. The shaft portion 5 is inserted through the strain generating body 22 via the hole portion 44. An edge portion 45 of the hole portion 44, the edge portion 45 which is at an opposite side to the control circuit portion 13, is formed in a shape which follows an outer circumference of the strain generating body 22. A pair of protruding pieces 46 and 46 is formed at an edge portion of the hole portion 44 in a manner that the protruding pieces 46 and 46 are positioned at the right and left of the shaft portion 5 and the wire 28, respectively. The protruding pieces 46 and 46 are positioned at an inner diameter side relative to the outer circumference of the strain generating body 22. In addition, an edge portion 47 of the hole portion 44, the edge portion 47 which is at the side of the control circuit portion 13, is also positioned at the inner diameter side relative to the outer circumference of the strain generating body 22. The protruding pieces 46, 46 and the edge portion 47 serve as a come-off-prevention portion of the strain generating body 22.

In a case where the load sensor 12 is configured by the strain generating body 22 and the sensor main body 21 which are separate from each other, the strain generating body 22 needs to be prevented from falling off from an operation member. As described above, in the embodiment, the hole portion 44 through which the shaft portion 5, which is inserted in the strain generating body 22, is inserted is provided at the base portion 41, and the protruding pieces 46 and the edge portion 47 which serve as the come-off-prevention portion that prevents the strain generating body 22 from coming off towards the base portion 41 are provided at the edge portion of the hole portion 44. Accordingly, the coming-off of the strain generating body 22 can be stably prevented and the load sensor 12 including a high detection accuracy can be obtained.

Each of the protruding pieces 46 and 46 is bent towards the strain generating body 22, thereby forming a bent portion 46a. Thus, the bent portion 46a can push and press the strain generating body 22, thereby holding the strain generating body 22 in a stable manner. In addition, a surface of the bent portion 46a is inclined towards an innermost side of the hole portion 44. Accordingly, the bent portion 46a can be used as a guide portion of the shaft portion 5 when the shaft portion S is being inserted into the hole portion 44, which makes an attachment operation of the load sensor 12 easy.

The support plate 15 includes a hole portion 51 through which the shaft portion 5 of the strain generating body 22 is inserted. At least part of an edge portion 52 of the hole portion 51 is bent towards the strain generating body 22. The edge portion 52 can be in contact with a lateral surface of the strain generating body 22, and the edge portion 52, together with the above-described bent portion 46a, retains the strain generating body 22 so that the strain generating body 22 is prevented from coining off.

The base plate 11 includes a hole portion 11a into which a rivet 53 is inserted. The base plate 11, the sensor main body 21 of the load sensor 12 and the support plate 15 are fastened in a state where the rivet 53 is inserted through hole portions provided at the respective members. The base plate 11 and the base portion 41 of the protection cover 14 are, for example, spot-welded at a fixing portion 48. The fixing portion 48 includes three points around the hole portion 44 which are arranged in a dispersed manner to form a triangular shape. The fastening method of the base plate 11, the load sensor 12 and the support plate 15, and the fastening method of the base plate 11 and the protection cover 14 are not specifically limited, and adhesion and/or screw fastening are applicable. The base portion 41 of the protection cover 14 includes an opening 41a formed at a position corresponding to the rivet 53.

Because the fixing portions 48 of the base portion 41 are arranged in the dispersed manner to form a polygonal shape including the three points, even if an external force supposedly applies to the cover portion 43 and the base portion 41 is to be away from the base plate 11, the plural fixing portions 48 can reliably inhibit the base portion 41 from coming off. For example, in a case where the external force acts on the cover portion 43 and the base portion 41 is to come off while the raised portion 42 that is continuous to the base portion serves as a fulcrum point, the fixing portion 48 that is the farthest from the raised portion 42 functions effectively because the fixing points are provided in the polygonal configuration. That is, a fixing strength of the fixing portion 48 is associated with a distance from the raised portion 42, and thus a fixing state of the protection cover 14 can be more stabilized by ensuring the distance to be long.

An attachment piece 17 for a wire harness is provided in a standing condition at a side end portion of the base plate 11. The attachment piece 17 includes a hole portion 17a. The wire harness extended from the control circuit portion 13 is placed at and held by a band member arranged at the hole portion 17a.

The base plate 11 includes an end portion 18 at the side at which the control circuit portion 13 is arranged and the end portion 18 is bent so that the control circuit portion 13 is restricted by the end portion 18 from moving rearward. The control circuit portion 13 is restricted by the raised portion 42 of the protection cover 14 from moving forward. In addition, the base plate 11 includes a bent portion 19 provided at each of the right and left sides of the control circuit portion 13, and the bent portions 19 hold both right and left sides of the control circuit portion 13.

[Other embodiment] (1) In the above-described embodiment, the example is shown in which the edge portion including a diameter that is smaller than an outer diameter of the strain generating body 22 is formed at the hole portion 44 of the base portion 41 of the protection cover 14, the edge portion which serves as the come-off-prevention portion of the strain generating body 22. However, the come-off-prevention portion of the strain generating body 22 may be any one position of the edge portion of the hole portion 44, or may be the entire edge portion.

(2) In the above-described embodiment, the example is shown in which the protruding pieces 46 and 46, which are provided at the edge portion of the hole portion 44 as the come-off-prevention portion of the strain generating body 22, are bent. However, the come-off-prevention portion may be formed to simply protrude to the hole portion 44 instead of being bent.

(3) In the above-described embodiment, the example is shown in which the communication portion for the wire that connects the load sensor 12 and the control circuit portion 13 to each other is provided at the hole portion 16 for the shaft portion 5 which is formed at the base plate 11. However, the communication portion may be configured by a hole portion formed, separately from the hole portion 16, at the base plate 11.

(4) In the above-described embodiment, the example is shown in which the fixing portions 48, relative to the base plate 11, of the base portion 41 of the protection cover 14 correspond to the three points. However, the fixing portions 48 may be arranged to form a polygonal shape including at least three points or e at the base portion 41. Accordingly, the fixing portions 48 may be four points or more.

(5) In the above-described embodiment, the example is shown in which a restriction portion (the end portion 18, the bent portion 19) is provided at the base plate 11 which restricts the control circuit portion 13 from moving towards the back surface side and towards the right and left sides. However, a similar restriction portion may be provided at the cover portion 43 of the protection cover 14.

### INDUSTRIAL APPLICABILITY

This invention is applicable widely to a load detection apparatus provided with a load sensor.

### EXPLANATION OF REFERENCE NUMERALS

1: operation pedal

5: shaft portion

10: load detection apparatus

11: base plate

12: load sensor

13: control circuit portion

14: protection cover

15: support plate

16: hole portion

16a: first hole portion

16b: second hole portion

21: sensor main body

22: strain generating body

28: wire

31: first surface of the base plate

32: second surface of the base plate

41: base portion

42: raised portion

43: cover portion

44: hole portion

45: edge portion

46: protruding piece (come-off-prevention portion)

47: edge portion (come-off-prevention portion)

48: fixing portion

1. A load detection apparatus comprising:
a base plate;
a load sensor provided at a first surface of the base plate;
a control circuit portion provided at a position on a second surface of the base plate, the position not overlapping the load sensor in a plan view of the base plate;
a protection cover covering the control circuit portion; and
the protection cover including:
a base portion covering at least part of a position on the second surface, the position facing the load sensor with the base plate therebetween,
a raised portion being continuous to the base portion, and
a cover portion being continuous to the raised portion and covering the control circuit portion.

2. The load detection apparatus according to claim 1, wherein a communication portion for a wire connecting the load sensor and the control circuit portion to each other is provided at the base plate.

3. The load detection apparatus according to claim 1, wherein a fixing portion of the base portion relative to the base plate is provided at at least three points or more in a dispersed manner to form a polygonal shape.

4. The load detection apparatus according to claim 1, wherein
the load sensor is formed of a strain generating body and a sensor main body which are divided from each other,
a hole portion through which a shaft portion supporting the strain generating body is inserted is formed at the base portion, and
a come-off-prevention portion preventing the strain generating body from coming off towards the base portion is provided at an edge portion of the hole portion.

5. The load detection apparatus according to claim 4, wherein the come-off-prevention portion is formed by being bent towards the strain generating body.
